(19) United States
(12) Patent Application Publication
(10) Pub. No.: US 2007/0236005 A1
(43) Pub. Date: Oct. 11, 2007

(54) Fitting device for compressed air pipe

(76) Inventor: Ching-Yi Chang, Chang Hua City (TW)

Correspondence Address: LEONG C LEI, PMB # 1008, 1867 YGNACIO VALLEY ROAD, WALNUT CREEK, CA, 94598, US

(21) Appl. No.: 11/392,795

(22) Filed: Mar. 30, 2006

(51) Int. Cl. F16L 35/00; F16L 27/00

(52) U.S. Cl. 285/80; 285/145.3

(57) ABSTRACT

A fitting device for connecting two air pipes is provided herein. A first connector at an end of a first air pipe has a number of steel balls rolling between an outer sliding tube and an inner tube. A second connector at an end of a second air pipe has a slant flange and a ring trough. When the second connector is plugged into the inner tube of the first connector, the steel balls fall within the ring trough to lock the two connectors together. When sliding tube is forced away from the second connector, the steel balls are out of the confinement of the ring trough, thereby unlocking the second connector.

### BACKGROUND OF THE INVENTION

(a) Technical Field of the Invention

The present invention generally relates to fitting device for connecting air pipes to an air compressor, and more particularly to a fitting device utilizing steel balls for reliable and fast connection and disconnection of air pipes.

(b) Description of the Prior Art

To connect two air pipes by a conventional fitting device, a user has to hold a first connector at an end of a first pipe in one hand and slide a sliding tube of the first connector backward to reveal an inner tube of the first connector. While holding the sliding tube backwards, the user has to hold a second pipe using the other hand and fit the inner tube of the first connector into a second connector of the second pipe. The user then releases the sliding tube and the two connectors (and, therefore, the two air pipes) are then securely cascaded.

The conventional fitting device has the following disadvantages. First of all, the user has to use both hands for the connection. If any one of his/her hand is hurt or not available, the connection would be quite difficult, if not impossible. Secondly, due to various factors such as the shaking of the hands and their coordination, the connection requires a number of times of trial and error before the air pipes are securely connected. Therefore, there is still quite some room for improving the fitting device of air pipes.

### SUMMARY OF THE INVENTION

The primary purpose of the present invention is to provides a fitting device for reliable and fast connection of two air pipes. At an end of a first air pipe, the fitting device provides a first connector having an inner tube sleeved in an outer sliding tube. A number of first tracks are provided on the outer surface of the inner tube along the axial direction to house a number of steel balls that can roll along the first tracks. Correspondingly, a number of second tracks are provided on the inner surface of the sliding tubes along the axial direction, each of which is partitioned by a flange into two segments. At an end of a second air pipe, the fitting device provides a second connector having a slant flange followed by ring trough.

When the second connector is plugged into the inner tube of the first connector, the slant flange of the second connector forces the steel balls to roll away from the flange of the first connector and into the deeper segments of the second tracks. When the ring trough is beneath the steel balls, the second connector is automatically locked. On the other hand, when the sliding tube is forced away from the second pipe, the steel balls fall within the outer segments of the second track, therefore releasing the second connector. When the sliding tube is released, a helix spring of the first connector returns the steel balls back to their original position. The foregoing connection and disconnection operations can all be done easily by single hand, which is a major feature of the present invention.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view showing the fitting device according to an embodiment of the present invention.

FIG. 2 is a sectional view showing the second connector of FIG. 1 is just plugged into the first connector of FIG. 1.

FIG. 3 is a sectional view showing the second connector of FIG. 1 is plugged deeper into the first connector of FIG. 1.

FIG. 4 is a sectional view showing how the first and second connectors of FIG. 1 are locked together.

FIG. 5 is a section view showing how compressed air flows through the first and second connectors of FIG. 1 after they are locked together.

FIG. 6 is a sectional view showing how the sliding tube of the first connector of FIG. 1 is about to release the second connector of FIG. 1.

FIG. 7 is a sectional view showing the second connector of FIG. 1 is unplugged from the first connector.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

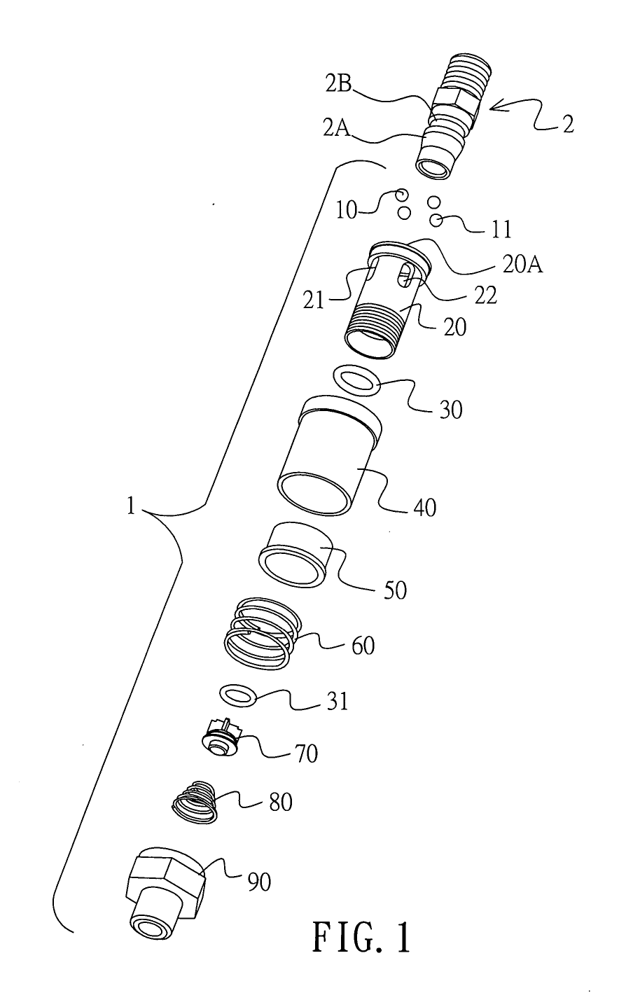

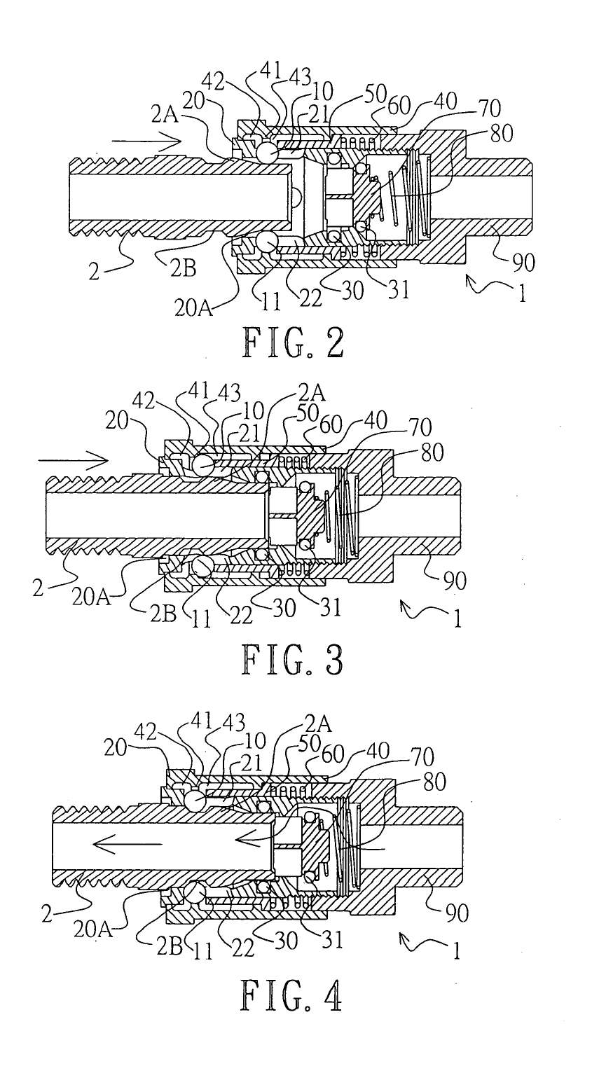

FIG. 1 is a perspective exploded view showing the fitting device according to an embodiment of the present invention. As illustrated, the fitting device contains a first connector 1 on an end of a first pipe (not shown) from an air compressor (not shown). The first connector 1 contains a number of steel balls 10 and 11, an inner tube 20, rings 30 and 311, a sliding tube 40, a positioning tube 50, a first helix spring 60, an air blocker 70, a second helix spring 80, and a tubular plug 90. Please also refer to FIG. 2. The positioning tube 50 is sleeved completely in the sliding tube 40, and the inner tube 20 is in turn sleeved through the positioning tube 50. An end (hereinafter, the first end) 20A of the inner tube 20 is for receiving a second connector 2 of the fitting device provided at an end of a second pipe (not shown). Threads (not numbered) are provided on the outer surface at the other end (hereinafter, the second end) of the inner tube 20 for joining to an end of the plug 90 having corresponding thread grooves (not numbered) on the inner surface. The plug 90 is joined to at an end of the first pipe from the air compressor. The first helix spring 60 is positioned inside the sliding tube 40 around the inner tube 20 and between the positioning tube 50 and the plug 90. The air blocker 70 surrounded by the rings 30 and 31 is positioned inside the inner tube 20 and directly interact with the second helix spring 80 housed inside the plug 90. The air blocker 70 can completely block the air to flow through the inner tube 20. Please note that first tracks 21 and 22 are provided on the surface close to the first end of the inner tube 20 where the steel balls 10 and 11 are positioned, respectively. The steel balls 10 and 11 can roll along the first tracks 21 and 22.

As shown in FIG. 2, along the inner surface of the sliding tube 40 and for each of the first tracks 21 and 22, there is a corresponding second track which is partitioned into segments 42 and 43 by a flange 41 surrounding the inner surface of the sliding tube 40. When the second pipe is not plugged in or is just plugged in, the steel balls 10 and 11 are confined between the flange 41 and the positioning tube 50 as the first helix spring 60 expands and pushes the positioning tube 50, within their respective first tracks 21 and 22.

The second connector 2 has a slant flange 2A adjacent to the end inserted to the first connector 1, followed by a ring trough 2B, both around the outer surface of the second connector 2. When the second connector 2 is plugged into the first end 20A of the inner tube 20, as shown in FIG. 3, the slant flange 2A of the second connector 2 forces the steel balls 10 and 11 to roll along the tracks 21 and 22. As the second connector 2 is inserted further, the steel balls 10 and 11 are forced away from the flange 41 and deeper into the segments 43. In the mean time, the first helix spring 60 is compressed as the steel balls 10 and 11 pushes the positioning tube 50 against the first helix spring 60. Once the ring trough 2B is beneath the steel balls 10 and 11, as shown in FIG. 4, the force from the slant flange 2A driving the steel balls 10 and 11 disappears and the steel balls 10 and 11 retreats as the first helix spring 60 expands and presses against the positioning tube 50. The steel balls 10 and 11 are therefore confined between the flange 41 and the ring trough 2B, reliably locking the second connector 2.

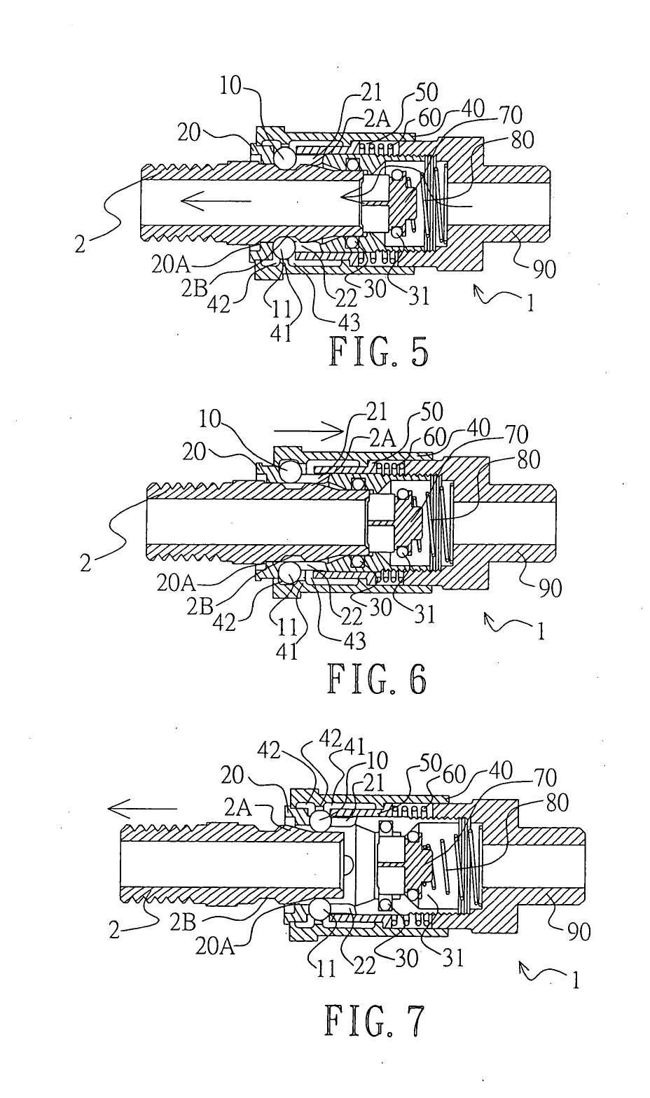

In the mean time, as shown in FIG. 5, the second connector 2 pushes the air blocker 70 so that the air from the air compressor can flow into the air pipe connected to the second connector 2. To unplug the second connector 2, as shown in FIG. 6, a user grabs the sliding tube 40 and forces it toward the plug 90. The segments 42 therefore approach to the top of the steel balls 10 and 11 and, as the positioning tube 50 compresses the first helix spring 60, the confinement to the steel balls 10 and 11 are relieved. Finally the steel balls 10 and 11 enter the segments 42, thereby unlocking the second connector 2.

The second helix spring 80 then expands and helps to eject the second connector 2 out of the first connector 1 so that the slant flange 2A is beneath the steel balls 10 and 11 again. When the sliding tube 40 is released, the first helix spring 60 expands, driving the positioning tube 50 and thereby the steel balls 10 and 11. On one hand, the steel balls 10 and 11 help to eject the second connector 2 even faster; on the other hand, the steel balls 10 and 11 are again positioned by the flange 41 within the first tracks 21 and 22.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fitting device for connecting a first pipe whose one end is connected to an air compressor and a second pipe, said fitting device comprising:
a second connector at an end of said second pipe having a slant flange in the front of said second connector followed by a ring trough, both around the outer surface of said second connector;
a first connector at the other end of said first pipe, said first connector having a plurality of steel balls, an inner tube, a plurality of rings, a sliding tube, a positioning tube, a first helix spring, an air blocker, a second helix spring, and a tubular plug, wherein said positioning tube is sleeved completely in said sliding tube, the inner tube is in turn sleeved through the positioning tube, a first end of said inner tube is for receiving said second connector, a second end of said inner tube is fixedly jointed to said plug which is connected to said first pipe, said first helix spring is positioned inside said sliding tube around said inner tube and between said positioning tube and said plug, said air blocker surrounded by said rings is positioned inside said inner tube and directly interact with said second helix spring housed inside said plug, said air blocker is capable of blocking the air to flow through said inner tube, a plurality of first tracks are provided on the outer surface close to said first end of said inner tube where said steel balls are positioned, respectively, a plurality of second tracks are provided along the inner surface of said sliding tube corresponding to said first tracks, each of which is partitioned into a front segment closer to said first end and a back segment by a flange surrounding the inner surface of said sliding tube 40;
wherein, when said second pipe is not plugged in, said steel balls are confined between said flange and said positioning tube as said first helix spring expands and pushes said positioning tube within their respective first tracks; when said second connector is plugged into said first end of said inner tube, said slant flange of said second connector forces said steel balls to roll along said first tracks; as said second connector is inserted further, said steel balls are forced away from said flange and deeper into said back segments; in the mean time, said first helix spring is compressed as said steel balls pushes said positioning tube against said first helix spring; once said ring trough is beneath said steel balls, said steel balls fall within said ring trough as said first helix spring expands and presses against said positioning tube; said steel balls are confined between said flange and said ring trough, thereby reliably locking said second connector;
the front end of said second connector pushes said air blocker open so that the air from said air compressor flows through said first and second pipes; when said sliding tube are forced toward said plug, said front segments therefore approach to the top of said steel balls and, as said positioning tube compresses said first helix spring, the confinement to said steel balls are relieved when said steel balls enter said front segments, thereby unlocking said second connector; said second helix spring expands and helps to eject said second connector out of said first connector; when said sliding tube is released, said first helix spring expands, driving said positioning tube and thereby said steel balls to eject said second connector; sand said steel balls are again positioned by said flange within said first tracks.
